(19) United States
(12) Patent Application Publication
(10) Pub. No.: US 2023/0411808 A1
(43) Pub. Date: Dec. 21, 2023

(54) Electrode Terminal, Current Collecting Assembly and Cylindrical Battery

(71) Applicant: JIANGSU ZENERGY BATTERY TECHNOLOGIES CO., LTD., Jiangsu (CN)

(72) Inventors: Yongjun LI, Jiangsu (CN); Yehui JIAO, Jiangsu (CN); Shengli CHEN, Jiangsu (CN); Hongjiang YU, Jiangsu (CN); Wuyuan ZOU, Jiangsu (CN)

(21) Appl. No.: 18/210,494

(22) Filed: Jun. 15, 2023

(30) Foreign Application Priority Data
Jun. 16, 2022 (CN) 202210681499.1
Dec. 27, 2022 (CN) 202211682759.3

(51) Int. Cl. H01M 50/559; H01M 50/107; H01M 50/152; H01M 50/179; H01M 50/536

(52) U.S. Cl. CPC H01M 50/559; H01M 50/107; H01M 50/152; H01M 50/179; H01M 50/536

(57) ABSTRACT

Disclosed is an electrode terminal, which includes a columnar portion and a first extension portion. An end surface of the columnar portion is concave inwards to form a first groove, the first extension portion extends outwards along a circumferential direction of the end surface of the columnar portion formed with the first groove, and an electric connection portion is formed at an end of the columnar portion away from the first groove. The electrode terminal in the disclosure is fitted with a current collecting assembly, a clamping process of the electrode terminal and the current collecting assembly is effectively omitted, a space utilization rate of a battery is improved, and the electrode terminal is welded to an external circuit more accurately and simply. In addition, further disclosed are a current collecting assembly and a cylindrical battery.

### CROSS-REFERENCE TO RELATED APPLICATION

The disclosure claims priority to and the benefits of Chinese Patent Application No. 202210681499.1, filed to the China National Intellectual Property Administration (CHIPA) on 16 Jun. 2022, and Chinese Patent Application No. 202211682759.3, filed to the China National Intellectual Property Administration (CHIPA) on 27 Dec. 2022, which are hereby incorporated by reference in their entireties.

### TECHNICAL FIELD

The disclosure relates to the technical field of battery manufacturing, and in particular to an electrode terminal, a current collecting assembly and a cylindrical battery.

### BACKGROUND

With the rapid growth of demand for renewable, non-polluting, small and discrete portable high-performance power sources, countries are vigorously developing green and high-efficiency secondary batteries. As a new type of secondary battery, a cylindrical battery has the advantages of high energy density and power density, high working voltage, light weight, small size, long cycle life, good safety, environmental protection, etc., and has broad application prospects in portable electrical appliances, electric tools, large energy storage, electric traffic power supply, etc.

Generally, when a top cover is connected to a housing of the cylindrical battery in a sealing manner, a current collecting member needs to be bent so that the current collecting member can be stored inside the battery. Thus, a space needs to be reserved inside the battery for the bent current collecting member, resulting in a reduction in the energy density of the battery. Meanwhile, an electrode terminal and the current collecting member mostly employ a process such as electric resistance welding or ultrasonic welding. It is necessary to clamp the electrode terminal and the current collecting member between two electrodes, which is implemented by current producing heat and has process defects such as complex production process and low production efficiency.

### SUMMARY

For shortcomings of the related art, some embodiments of the disclosure provide an electrode terminal, which is able to satisfy concave-convex assembly with a current collecting assembly, thus effectively saving a clamping process of the electrode terminal and the current collecting assembly and improving a space utilization rate of a battery. Moreover, the electrode terminal is welded to an external circuit more accurately and simply.

In order to achieve the above objective, the disclosure adopts a technical solution as follows.

An electrode terminal includes:
a columnar portion, an end surface of the columnar portion is concave inwards to form a first groove; and
a first extension portion, extending outwards along a circumferential direction of the end surface of the columnar portion formed with the first groove;
an electric connection portion, formed at an end of the columnar portion away from the first groove.

In some embodiments, a second groove is formed in a side surface of the columnar portion.

In some embodiments, a third groove is formed in a surface of the columnar portion away from the first groove.

In some embodiments, the third groove is arranged around the electric connection portion.

In some embodiments, the third groove is an annular continuous groove, or an annular discontinuous groove.

Some other embodiments of the disclosure provide a current collecting assembly for electric connection to the electrode terminal as described above, which includes:
a first current collecting member, including a first protrusion, an end surface of the first protrusion is provided with a first welding portion, the first protrusion is embedded in the first groove of the columnar portion, and the first protrusion and the first groove are welded at the first welding portion; and
a second current collecting member, the first current collecting member is insulated from the second current collecting member.

In some embodiments, the first welding portion is located in the third groove of the columnar portion.

In some embodiments, the first current collecting member and the second current collecting member are arranged separately.

In some embodiments, the current collecting assembly further includes an insulating part, the insulating part is configured for insulating connection with the first current collecting member and the second current collecting member, and the insulating part, the first current collecting member and the second current collecting member are integrally molded.

In some embodiments, the insulating part is provided with a through hole and an opening area, the first current collecting member is installed in the insulating part, the first protrusion passes through the through hole, the opening area is at least arranged on one side away from the first protrusion, at least a part of one side of the first current collecting member away from the first protrusion is exposed in the opening area, and the first current collecting member and the second current collecting member both form a welding area on one side away from the first protrusion.

Still some other embodiments of the disclosure provide a cylindrical battery, which includes:
the current collecting assembly and the electrode terminal as described above;
a housing and a cell, the cell includes a main body portion as well as a first tab unit and a second tab unit respectively arranged on the main body portion and opposite in polarity, and the cell is accommodated in the housing; and
the first current collecting member is electrically connected to the first tab unit, and the second current collecting member is electrically connected to the second tab unit.

In some embodiments, the housing includes a bottom wall and a side wall arranged on the edge of the bottom wall, the cylindrical battery further includes a top cover covering the housing, and the top cover is provided with an electrode lead-out hole, the electrode terminal passes through the electrode lead-out hole and is fixed to the top cover in an insulated manner by a sealing part.

In some embodiments, the first current collecting member is welded to the first tab unit, and the second current collecting member is welded to the second tab unit.

In some embodiments, the first tab unit and the second tab unit are led out from the same end of the main body portion, the first current collecting member is connected to the second current collecting member in a combined manner by an insulating part, and the top cover is welded to the second current collecting member.

In some embodiments, a fourth groove is formed in one side of the top cover away from the cell, and the fourth groove is configured to be welded to the second current collecting member.

The disclosure has at least the following beneficial effects: the electrode terminal of the disclosure includes the columnar portion and the first extension portion, an end of the columnar portion is concave inwards to form the first groove, and the first groove is configured to accommodate the current collecting assembly and the electrode terminal is fitted with the current collecting assembly by the first groove, so that the assembly space of the current collecting assembly and the electrode terminal is small, the clamping process of the electrode terminal and the current collecting assembly is saved, and the space utilization rate of the battery is improved. Moreover, the first extension portion extends outwards along the circumferential direction of the end surface of the columnar portion formed with the first groove, and the electrode terminal is assembled with the sealing part by the first extension portion, so that bonding strength between the electrode terminal and the sealing part is improved, and the safety performance of the battery is improved. The electric connection portion is formed at the end of the columnar portion away from the first groove, and the electric connection portion is able to ensure more accurate and simple welding between the electrode terminal and the external circuit. Therefore, the electrode terminal achieves efficient and stable assembly with the current collecting assembly, the sealing part and the external circuit, and efficiency in battery assembly and production is significantly improved.

### BRIEF DESCRIPTION OF THE DRAWINGS

Features, advantages, and technical effects of embodiments of the disclosure will be described below with reference to the accompanying drawings.

FIG. 1 is a three-dimensional structural schematic diagram of a cylindrical battery according to an embodiment of the disclosure.

FIG. 2 is a three-dimensional structural schematic diagram of disassembly of a cylindrical battery according to an embodiment of the disclosure.

FIG. 3 is a sectional view of a cylindrical battery according to an embodiment of the disclosure.

FIG. 4 is another sectional view of a cylindrical battery according to an embodiment of the disclosure.

FIG. 5 is a top view of a cylindrical battery according to an embodiment of the disclosure.

FIG. 6 is another top view of a cylindrical battery according to an embodiment of the disclosure.

FIG. 7 is a three-dimensional structural schematic diagram of an electrode terminal according to an embodiment of the disclosure.

FIG. 8 is another three-dimensional structural schematic diagram of an electrode terminal according to an embodiment of the disclosure.

FIG. 9 is a sectional view of an electrode terminal according to an embodiment of the disclosure.

FIG. 10 is a three-dimensional schematic structural diagram of a top cover according to an embodiment of the disclosure.

FIG. 11 is a three-dimensional schematic structural diagram of a sealing part according to an embodiment of the disclosure.

FIG. 12 is a sectional view of a current collecting assembly according to an embodiment of the disclosure.

FIG. 13 is a three-dimensional structural diagram of disassembly of a battery module according to an embodiment of the disclosure.

### REFERENCE NUMERALS ARE EXPLAINED BELOW

1. housing; 11. bottom wall; 12. side wall;
2. cell; 21. main body portion; 22. first tab unit; 221. first tab; 23. second tab unit; 231. second tab;
3. top cover;
4. electrode terminal; 41. first groove; 42. base portion; 43. columnar portion; 44. first extension portion; 421. electric connection portion; 422. third groove; 431. second groove;
5. current collecting assembly; 51. first current collecting member; 510. first protrusion; 511. first welding portion; 5111. first welding subpart; 5112. second welding subpart; 512. first connection portion; 5121. surrounding subpart; 5122. first connection subpart; 5123. second connection subpart; 52. second current collecting member; 521. second welding portion; 522. second connection portion; 53. insulating part;
6. battery module; 61. box; 611. first box portion; 612. second box portion; 613. third box portion; 62. cylindrical battery;
70. electrode lead-out hole; 71. fourth groove; 72, sealing part; 721. avoidance hole; 73. injection port; 74. explosion-proof weakness part;
X. horizontal direction; Y. longitudinal direction.

### DETAILED DESCRIPTION OF THE EMBODIMENTS

Certain terms are used, for example, in the specification and claims to refer to particular components. Those skilled in the art should understand that a hardware manufacturer may use different terms to refer to the same component. The specification and claims do not use the difference in name as a way to distinguish components, but use the difference in function of components as a criterion for distinguishing. As mentioned throughout the specification and claims, “comprising” is an open term, so it should be interpreted as “including but not limited to”. “Approximately” means that within an acceptable error range, those skilled in the art can solve technical problems within a certain error range and basically achieve technical effects.

In addition, terms “first” and “second” are only used for describing purposes, and cannot be understood as indicating or implying relative importance.

In the disclosure, unless otherwise clearly specified and limited, the terms “installation”, “mutual connection”, “connection”, “fixation” and other terms shall be understood in a broad sense. For example, the term may be a fixed connection or a detachable connection, or an integrated connection; the term may be a mechanical connection or an electric connection; and the term may be a direct connection or an indirect connection through an intermediary, and may be communication inside two components. Those of ordinary skill in the art may understand the specific meanings of the terms in the disclosure according to specific conditions.

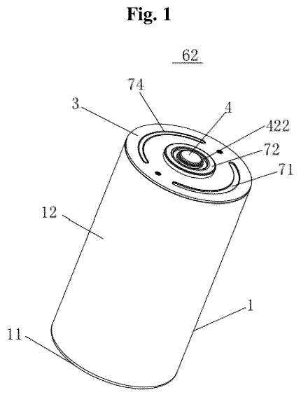

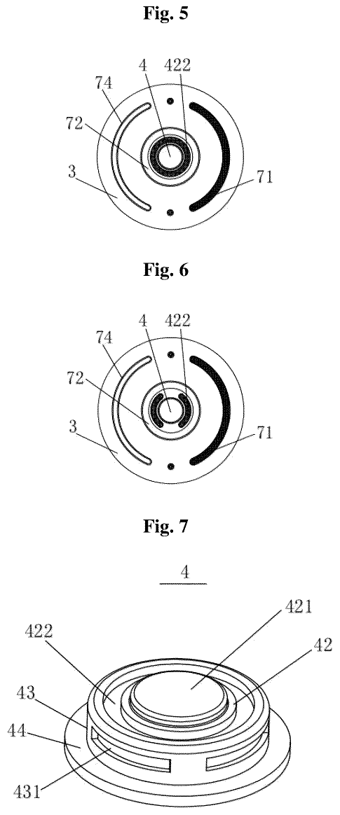

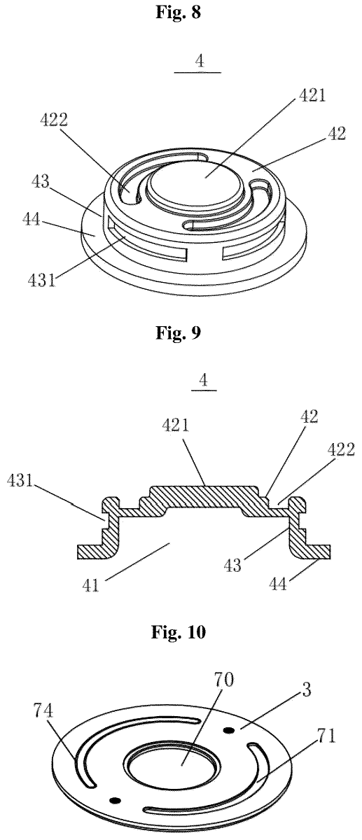

The disclosure will be described by the following embodiments in further detail in conjunction with FIGS. 1-13 of the accompanying drawings, but is not limited thereto.

As shown in FIG. 1, a cylindrical battery 62 of the embodiment of the disclosure includes a housing 1, a cell 2, a top cover 3, an electrode terminal 4, a sealing part 72 and a current collecting assembly 5. The cell 2 is accommodated in the housing 1. The cell 2 includes a main body portion 21 as well as a first tab unit 22 and a second tab unit 23 opposite in polarity. The first tab unit 22 and the second tab unit 23 are led out from the same end of the main body portion 21. The current collecting assembly 5 includes a first current collecting member 51, a second current collecting member 52 and an insulating part 53, the first current collecting member 51 is insulated from the second current collecting member 52, and the first current collecting member 51 is connected to the second current collecting member 52 in a combined manner by the insulating part 53. The first current collecting member 51 is welded to the first tab unit 22, and the second current collecting member 52 is welded to the second tab unit 23. A first protrusion 510 is formed on the first current collecting member 51. The top cover 3 is connected to the housing 1, an electrode lead-out hole 70 is formed in the top cover 3, and the top cover 3 is welded to the second current collecting member 52. The electrode terminal 4 passes through the electrode lead-out hole 70 and is fixed to the top cover 3 in an insulated manner, a first groove 41 is formed in one side of the electrode terminal 4 towards the current collecting assembly 5, and the first protrusion 510 extends into the first groove 41 and is welded to the first groove 41.

In some embodiments, the first current collecting member 51 and the second current collecting member 52 are arranged separately. The insulating part 53 is arranged between the first current collecting member 51 and the second current collecting member 52; or the first current collecting member 51 and the second current collecting member 52 are insulated without arranging any parts therebetween. When the current collecting assembly includes the insulating part 53, the insulating part 53 is connected to the first current collecting member 51 and meanwhile is separately arranged with the second insulating member 52; or the insulating part 53 is connected to the second current collecting member 52 and meanwhile is separately arranged with the first current collecting member 51.

In some embodiments, the insulating part 53, the first current collecting member 51 and the second current collecting member 52 are integrally molded.

In some embodiments, the insulating part 53 is provided with a through hole and an opening area, the first current collecting member 51 is installed in the insulating part 53, the first protrusion 510 passes through the through hole, the opening area is at least arranged on one side away from the first protrusion 510, at least a part of one side of the first current collecting member 51 away from the first protrusion 510 is exposed in the opening area, and the first current collecting member 51 and the second current collecting member 52 both form a welding area on one side away from the first protrusion 510.

The opening area of the insulating part 53 is arranged only on one side away from the first protrusion 510, or is arranged on sides close to and away from the first protrusion 510 at the same time, so that the opening area is exposed on one side or exposed on two sides. When the opening area is only arranged on the side away from the first protrusion 510 and is exposed on one side, the first current collecting member 51 is exposed on the side away from the first protrusion 510 so as to form an electric connection with a tab, and the other side of the first current collecting member 51 and the top cover 3 are spaced by the insulating part 53, so as to achieve an insulation between the first current collecting member 51 and the top cover 3.

Compared with leading out the tab from two ends of the cell 2, the first tab unit 22 and the second tab unit 23 are led out from the same end of the main body portion 21 of the cell 2 of the disclosure, which reduces a space occupied by the tab on the cylindrical battery. In order to enable the first tab unit 22 and the second tab unit 23 to perform energy transfer with an external circuit, the first tab unit 22 is electrically connected to the first current collecting member 51, the second tab unit 23 is electrically connected to the second current collecting member 52, then the first current collecting member 51 is welded to the electrode terminal 4, and the second current collecting member 52 is welded to the top cover 3, so that the first tab unit 22 is able to transfer a current to the electrode terminal 4 by the first current collecting member 51, the second tab unit 23 is able to transfer the current to the top cover 3 by the second current collecting member 52, and then the cell 2 is electrically connected to the external circuit by the electrode terminal 4 and the top cover 3. As the first current collecting member 51 and the second current collecting member 52 are electrically connected to the first tab unit 22 and the second tab unit 23 respectively, in order to avoid an accidental contact between the first current collecting member 51 and the second current collecting member 52, resulting in a short circuit of the cylindrical battery, the first current collecting member 51 and the second current collecting member 52 are assembled in an insulated manner by the insulating part 53. In the disclosure, the first protrusion 510 is formed on the first current collecting member 51, and the first groove 41 is formed in the corresponding electrode terminal 4. When the top cover 3 covers the housing 1, the first protrusion 510 extends into the first groove 41, so that the first protrusion 510 is in contact with the first groove 41, the first current collecting member 51 is electrically connected to the electrode terminal 4, and the second current collecting member 52 is in contact with the top cover 3, thus ensuring welding of the second current collecting member 52 to the top cover 3 to achieve an electric connection, so that the disclosure is able to complete the contact between the first current collecting member 51 and the electrode terminal 4 and the contact between the second current collecting member 52 and the top cover 3 without an additional clamping process, so as to ensure a welding quality of the first current collecting member 51 to the electrode terminal 4 and a welding quality of the second current collecting member 52 to the top cover 3.

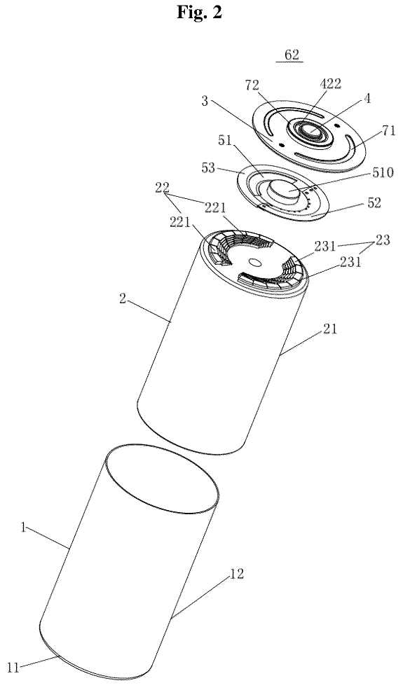

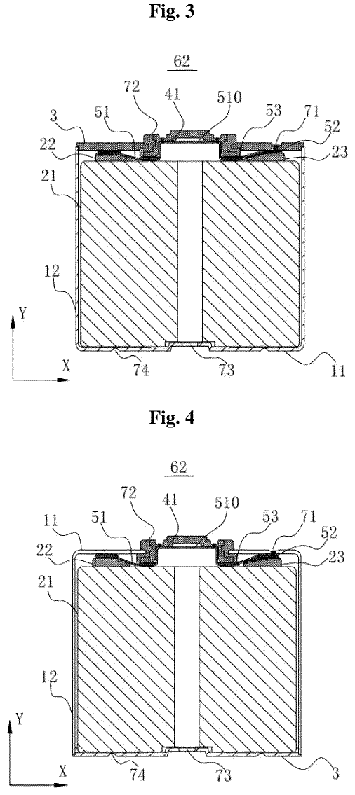

As shown in FIGS. 2-3, in some embodiments, the top cover 3 is a disc-shaped structure, the electrode lead-out hole 70 is arranged in the center of the top cover 3, the electrode terminal 4 is a cylindrical structure provided with the first groove 41, and one side of the electrode terminal 4 towards the cell 2 is concave inwards to form the first groove 41. The electrode terminal 4 passes through the electrode lead-out hole 70 and is fixed to the top cover 3 in an insulated manner. The sealing part 72 is arranged between the top cover 3 and the electrode terminal 4. The sealing part 72 is a cylindrical structure and is provided with an avoidance hole 721. The sealing part 72 passes through the electrode lead-out hole the electrode terminal 4 passes through the avoidance hole 721, and the avoidance hole 721 of the sealing part 72 matches a side surface of the electrode terminal 4. It should be noted that, in some embodiments, the sealing part 72 is a plastic part formed by a nano-injection molding process. By performing laser engraving or chemical etching on a connection area between the electrode terminal 4 and the sealing part 72, nano-micropores are formed in the connection area, and laser engraving or chemical etching is performed on a connection area between the top cover 3 and the sealing part 72 to form the nano-micropores in the connection area, and then Polyphenylenesulphide (PPS) is injected between the top cover 3 and the electrode terminal 4 to form the sealing part 72.

As shown in FIGS. 2-3, in some embodiments, the housing 1 includes a bottom wall 11 and a side wall 12 arranged on the edge of the bottom wall 11, and the bottom wall 11 and the side wall 12 are integrally molded. The housing 1 is a cylindrical structure, and the housing 1 is configured to accommodate the cell 2. The bottom wall 11 of the housing 1 is provided with an injection port 73 and an explosion-proof weakness part 74, the injection port 73 serves as a channel through which an electrolyte is injected into the cylindrical battery, the explosion-proof weakness part 74 is a groove formed by laser engraving or chemical etching, and the explosion-proof weakness part 74 is opened in time for pressure relief when thermal runaway occurs to the cylindrical battery.

As shown in FIG. 4, in some other embodiments, the side wall 12 and the top cover 3 are integrally molded, the bottom wall 11 and the side wall 12 are arranged separately, and the bottom wall 11 and the side wall 12 are welded by laser welding.

As for the cell 2, the main body portion 21 of the cell 2 is formed by winding a positive electrode plate, a separator and a negative electrode plate in sequence. The cylindrical battery works primarily by moving of metal ions between the positive electrode plate and the negative electrode plate. The positive electrode plate includes a positive current collector and a positive active material layer, and the positive active material layer is coated on a surface of the positive current collector. The positive current collector includes a positive coating area and a positive tab connected to the positive coating area, the positive coating area is coated with the positive active material layer, and the positive tab is not coated with the positive active material layer. Taking a lithium ion battery as an example, a material of the positive current collector is aluminum, the positive active material layer includes a positive active material, and the positive active material is lithium cobaltate, lithium iron phosphate, ternary lithium or lithium manganate, etc. The negative electrode plate includes a negative current collector and a negative active material layer, and the negative active material layer is coated on a surface of the negative current collector. The negative current collector includes a negative coating area and a negative tab connected to the negative coating area, the negative coating area is coated with the negative active material layer, and the negative tab is not coated with the negative active material layer. A material of the negative current collector is copper, the negative active material layer includes a negative active material, and the negative active material is carbon, or silicon, etc. A material of the separator is polypropylene (PP) or polyethylene (PE), etc. In some embodiments, by cutting the positive electrode plate, a plurality of first tabs 221 are obtained, and by cutting the negative electrode plate, a plurality of second tabs 231 are obtained. After the positive electrode plate, the separator and the negative electrode plate are wound in sequence to form the cell 2, the first tab unit 22 is obtained by performing kneading or flattening processing on the plurality of first tabs 221, and the second tab unit 22 is obtained by performing kneading or flattening processing on the plurality of second tabs 231. In some embodiments, the plurality of first tabs 221 and the plurality of second tabs 231 are led out from the same end of the main body portion 21.

As shown in FIG. 3 or FIG. 4, in some embodiments, kneading or flattening processing is performed on the plurality of first tabs 221 to obtain the first tab unit 22 with a trapezoidal structure in a longitudinal Y section. By cutting the negative tab, after the positive electrode plate, the separator and the negative electrode plate are wound in sequence to form the cell 2, the plurality of second tabs 231 are obtained, and kneading or flattening processing is performed on the plurality of second tabs 231 to obtain the second tab unit 23 with the trapezoidal structure in the longitudinal Y section. In addition, the first tab unit 22 is insulated from the second tab unit 23. It should be noted that the first tab 221 is also able to be obtained by cutting the negative electrode plate, and the second tab 231 is also able to be obtained by cutting the positive electrode plate.

As shown in FIG. 3 or FIG. 4, the current collecting assembly 5 further includes the second current collecting member 52 and the insulating part 53, and the first current collecting member 51 and the second current collecting member 52 are in insulating connection by the insulating part 53. The first current collecting member 51 is electrically connected to the first tab unit 22, and a part of the first current collecting member 51 is configured to be the same as the shape of one side of the first tab unit 22 away from the cell 2. The first current collecting member 51 is configured with the above shape, so that the first current collecting member 51 is able to be well attached to the first tab unit 22, thus increasing a contact area between the first current collecting member 51 and the first tab unit 22, and further increasing a current passing area of a welding structure formed by the first tab unit 22 and the first current collecting member 51. Meanwhile, the first current collecting member 51 is provided with the first protrusion 510, the first protrusion 510 extends into the first groove 41 of the electrode terminal 4 and is welded with the first groove 41; therefore, the first current collecting member 51 and the electrode terminal 4 are electrically connected by a welding of the first protrusion 510 and the first groove 41.

A side of the second current collecting member 52 is electrically connected to the second tab unit 23. The shape of the second current collecting member 52 is the same as that of a side of the second tab unit 23 away from the cell 2. The second current collecting member 52 is configured with the above shape, so that the second current collecting member 52 is able to be well attached to the second tab unit 23, thus increasing a contact area between the second current collecting member 52 and the second tab unit 23, and further increasing a current passing area of a welding structure formed by the second tab unit 23 and the second current collecting member 52. Meanwhile, the top cover 3 or the housing 1 abuts against the second current collecting member 52, and the second current collecting member 52 is electrically connected to the top cover 3 by laser keyhole welding or spot welding on bottom.

Since the first current collecting member 51 and the second current collecting member 52 are located at the same end of the cell 2, it is easy to contact. The first current collecting member 51 is electrically connected to the first tab unit 22, and the second current collecting member 52 is electrically connected to the second tab unit 23; therefore, a polarity of the first current collecting member 51 is opposite to a polarity of the second current collecting member 52. A contact between the first current collecting member 51 and the second current collecting member 52 will cause a short circuit; therefore, the first current collecting member 51 is in insulating connection with the second current collecting member 52 by the insulating part 53, and a direct contact between the first current collecting member 51 and the second current collecting member 52 is avoided. Meanwhile, after the first current collecting member 51 and the second current collecting member 52 are connected by the insulating part 53, an overall current collecting assembly 5 is obtained. The entire current collecting assembly 5 is clamped for placing by clamping only any part of the current collecting assembly 5. It should be understood that the insulating part 53 is formed by injection molding PP(polypropylene) between the first current collecting member 51 and the second current collecting member 52.

As shown in FIGS. 7-9, in some embodiments, the electrode terminal 4 includes a base portion 42, a columnar portion 43 and a first extension portion 44. The columnar portion 43 is connected to the base portion 42, the first extension portion 44 is connected to the columnar portion 43, the columnar portion 43 extends towards the cell 2, and the first extension portion 44 extends in a horizontal direction X, and the base portion 42 and the columnar portion 43 form the first groove 41. An end surface of the columnar portion 43 is concave inwards to form the first groove 41, and the first extension portion 44 extends outwards in a circumferential direction of the end surface of the columnar portion 43 formed with the first groove 41.

In the above embodiment, the electrode terminal 4 passes through the electrode lead-out hole 70, and a distance between a surface of the base portion 42 away from the cell 2 and the cell 2 is greater than a distance between a surface of the top cover 3 away from the cell 2 and the cell 2, that is, the base portion 42 protrudes from the top cover 3 in the longitudinal direction Y. Since welding positions of the electrode terminal 4 and the external circuit are all in the base portion 42 when welded, in order to facilitate a welding of the base portion 42 to the external circuit, and prevent the external circuit welded with the base portion 42 from mistakenly touching the top cover 3 to cause the short circuit, the base portion 42 is arranged to protrude from the top cover 3. The columnar portion 43 is connected to the base portion 42, and meanwhile the columnar portion 43 extends towards a side of the cell 2 to form the first groove 41. After the top cover 3 covers the housing 1, the first groove 41 abuts against the first current collecting member 51, therefore, there is no need to adopt a clamping workpiece to clamp the first groove 41 and the first current collecting member 51 for welding. The first extension portion 44 is connected to the columnar portion 43, the first extension portion 44 extends in the horizontal direction X, and a projected area of the first extension portion 44 in the longitudinal direction Y is greater than a projected area of the electrode lead-out hole 70 in the longitudinal direction Y. Since the projected area of the first extension portion 44 in the longitudinal direction Y is greater than the projected area of the electrode lead-out hole 70 in the longitudinal direction Y, the first extension portion 44 cooperates with the sealing part 72 so that the electrode terminal 4 is limited from being displaced in the longitudinal direction Y. It should be noted that, in the embodiment, the base portion 42 is a disc-shaped structure, the columnar portion 43 is a barrel structure, the first groove 41 is a columnar structure, and the first extension portion 44 is a ring-shaped structure.

In some embodiments, a side of the base portion 42 away from the cell 2 is provided with a third groove 422, the third groove 422 is formed in a surface of the columnar portion 43 away from the first groove 41, and the third groove 422 is configured to be welded to the first current collecting member 51. The base portion 42 is provided with the third groove 422, when the first current collecting member 51 and the electrode terminal 4 are subjected to keyhole welding, a welding head is directly aligned with the third groove 422 for welding, so that the welding of the first current collecting member 51 to the electrode terminal 4 is completed. A welding point of the electrode terminal 4 and the first current collecting member 51 is located in the third groove 422 of the columnar portion 43. Since a thickness of the base portion 42 is the smallest at the third groove 422, welding is performed more quickly. Meanwhile, since the third groove 422 is a groove, all welding slag formed during welding is accommodated in the third groove 422, reducing a risk of splashing of the welding slag. It should be noted that the third groove 422 is a ring-shaped structure or an arc-shaped strip structure. When the third groove 422 is arranged in the arc-shaped strip structure, there are the plurality of third grooves 422, and the plurality of third grooves 422 are evenly distributed around a center of the electrode terminal 4. The number of the third grooves 422 is 1, 2, 3, 4, 5 and so on. The third groove 422 is an annular continuous groove, or an annular discontinuous groove.

In some embodiments, the base portion 42 is provided with an electric connection portion 421. The electric connection portion 421 is formed at an end of the columnar portion 43 away from the first groove 41, the electric connection portion 421 is arranged on a side of the base portion 42 away from the cell 2, and the third groove 422 is arranged around the electric connection portion 421. By arranging the electric connection portion 421 on the side of the base portion 42 away from the cell 2, the electric connection portion 421 makes a welding between the electrode terminal 4 and the external circuit more accurate and simple, and meanwhile the third groove 422 is arranged around the electric connection portion 421.

In some embodiments, the columnar portion 43 is provided with a second groove 431, the second groove 431 is arranged on a surface of the columnar portion 43 connected to the top cover 3, and the second groove 431 is formed in a side surface of the columnar portion 43. The second groove 431 is formed in the columnar portion 43 so that a connection area between the columnar portion 43 and the sealing part 72 is increased, and a connection area between the electrode terminal 4 and the sealing part 72 is further increased, and a connection strength and sealing performance between the electrode terminal 4 and the sealing part 72 is improved. It should be noted that the second groove 431 is a ring-shaped structure, the second groove 431 is also an arc-shaped structure, and both the ring-shaped structure and the arc-shaped structure are arranged around the columnar portion 43.

In some embodiments, the number of the second grooves 431 is one or more, and the plurality of second grooves 431 are evenly arranged around the columnar portion 43. By arranging the plurality of second grooves 431 evenly around the columnar portion 43, the connection area between the columnar portion 43 and the sealing part 72 is increased. Meanwhile, the electrode terminal 4 is a hollow structure, the second groove 431 is concave inwards in the columnar portion 43 so that the thickness of the second groove 431 is smaller than the thickness of other positions of the columnar portion 43, thus causing a structural strength of the second groove 431 to be lower than a structural strength of other positions of the columnar portion 43; therefore, in order to ensure a structural strength of the electrode terminal 4, the structural strength of the columnar portion 43 is well ensured by evenly arranging the plurality of second grooves 431 with the arc-shaped structure around the columnar portion 43. It should be noted that the number of the second grooves 431 is 3, 4, 5, 6 and so on. In an embodiment, the number of the second grooves 431 is 4.

In some embodiments, the first current collecting member 51 is welded to the first tab unit 22, and the second current collecting member 52 is welded to the second tab unit 23.

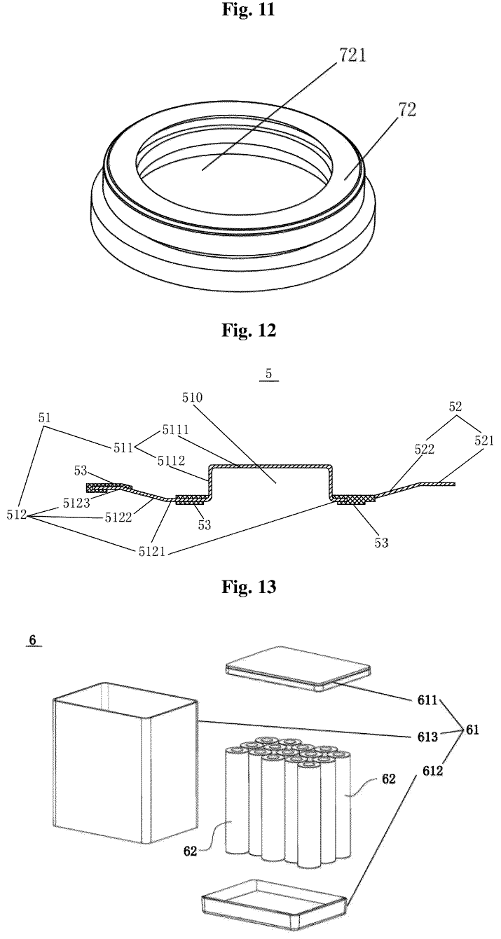

As shown in FIG. 12, in some embodiments, the first current collecting member 51 includes a first welding portion 511 and a first connection portion 512. The first connection portion 512 is welded to the first tab unit 22, and the first welding portion 511 is welded to the first groove 41. The second current collecting member 52 includes a second welding portion 521 and a second connection portion 522, the second connection portion 522 is welded to the second tab unit 23, and the second welding portion 521 is welded to the top cover 3. Specifically, the first welding portion 511 is arranged on an end surface of the first protrusion 510, the first protrusion 510 is embedded into the first groove 41 of the columnar portion 43, and the first protrusion 510 and the first groove 41 are welded at the first welding portion 511.

In the above embodiment, a shape of the first welding portion 511 is columnar and matches a shape of the first groove 41 of the electrode terminal 4, so that when the first current collecting member 51 is welded to the electrode terminal 4, a laser keyhole welding between the first welding portion 511 and the first groove 41 is enabled without clamping the first current collecting member 51 and the electrode terminal 4. A part of the first connection portion 512 is attached to the first tab unit 22, so that laser keyhole welding, ultrasonic welding or resistance welding between the part of the first connection portion 512 and the first tab unit 22 is enabled. Meanwhile, the first connection portion 512 is attached to the first tab unit 22, so that a connection area between the first current collecting member 51 and the first tab unit 22 is increased, and then a current passing area is increased.

In the above embodiment, the second welding portion 521 abuts against the top cover 3, and meanwhile is attached to the part of the second tab unit 23. The part of the second connection portion 522 is attached to the second tab unit 23. The second welding portion 521 and the second connection portion 522 abut against the second tab unit 23, so that the connection area between the second current collecting member 52 and the first tab unit 22 is increased, and then the current passing area is increased. Meanwhile, since the second welding portion 521 is parallel to the top cover 3, and a surface of the top cover 3 away from the cell 2 is provided with a fourth groove 71, a laser keyhole welding between the fourth groove 71 and the second welding portion 521 is performed without clamping the second current collecting member 52 and the top cover 3, and the second connection portion 522 is attached to the second tab unit 23 for the laser keyhole welding, ultrasonic welding or resistance welding. It should be noted that both the second welding portion 521 and the second connection portion 522 are both arc-shaped plate structures, and a difference is that the second connection portion 522 is an inclined arc-shaped plate structure. In addition, the second welding portion 521 and the second connection portion 522 are integrally molded.

As shown in FIG. 12, the first welding portion 511 includes a first welding subpart 5111 and a second welding subpart 5112. The second welding subpart 5112 is arranged on the edge of the first welding subpart 5111, and the second welding subpart 5112 extends towards a side of the cell 2 to form the first protrusion 510 with the first welding subpart 5111. The first welding subpart 5111 is welded to the first groove 41, and the second welding subpart 5112 is connected to the first connection portion 512.

In the above embodiment, in order to ensure that the first current collecting member 51 is able to be welded to the electrode terminal 4 and also be electrically connected to the first tab unit 22, the first welding portion 511 is arranged as the first welding subpart 5111 and the second welding subpart 5112. The first welding subpart 5111 abuts against the base portion 42 of the electrode terminal 4. Since the base portion 42 and the columnar portion 43 form the first groove 41, the second welding subpart 5112 protrudes from the edge of the first welding subpart 5111 to a side of the cell 2 in the longitudinal direction Y, and the first welding subpart 5111 and the second welding subpart 5112 form the first protrusion 510, so that the first protrusion 510 and the first groove 41 are subjected to laser keyhole welding. In order to enable the first current collecting member 51 to be electrically connected to the first tab unit 22, the second welding subpart 5112 is connected to the first connection portion 512, and the first connection portion 512 is electrically connected to the first table unit 22; therefore, the second welding subpart 5112 is electrically connected to the first tab unit 22 by being connected to the first connection portion 512. It should be noted that the first welding subpart 5111 is a disc-shaped structure, the second welding subpart 5112 is a cylindrical structure, and the first welding subpart 5111, the second welding subpart 5112 and the first connection portion 512 are integrally molded.

As shown in FIG. 12, the first connection portion 512 includes a surrounding subpart 5121, a first connection subpart 5122 and a second connection subpart 5123.

The surrounding subpart 5121 is connected to the second welding subpart 5112, the surrounding subpart 5121 abuts against an end surface of the main body portion 21, a surface of the surrounding subpart 5121 close to the cell 2 and a surface of the surrounding subpart 5121 away from the cell 2 are provided with the insulating part 53, and the surrounding subpart 5121 close to a side of the second current collecting member 52 is in insulating connection with the second current collecting member 52 by the insulating part 53.

The first connection subpart 5122 is connected to the surrounding subpart 5121, the second connection subpart 5123 is connected to the first connection subpart 5122, the first connection subpart 5122 is welded to the first tab unit 22, and the insulating part 53 is sleeved on the second connection subpart 5123.

In the above embodiment, the surrounding subpart 5121 is a ring-shaped structure, and the surrounding subpart 5121 is arranged on the edge of the second welding subpart 5112. The insulating part 53 performs insulating connection on the surrounding subpart 5121 close to the side of the second current collecting member 52 and the second connection portion 522 of the second current collecting member 52, so that the first current collecting member 51 and the second current collecting member 52 form a whole. Since the second current collecting member 52 and the first current collecting member 51 constitute the current collecting assembly 5 by the insulating part 53, greater convenience is brought for placing the first current collecting member 51 and the second current collecting member 52. Meanwhile, the second current collecting member 52 and the first current collecting member 51 are insulated by the insulating part 53, so that the second current collecting member 52 is prevented from contacting the first current collecting member 51 to cause the short circuit. Since the surrounding subpart 5121 abuts against an end surface of the main body portion, the insulating part 53 is arranged on a side of the surrounding subpart 5121 away from the cell 2, and meanwhile, the insulating part 53 is arranged on a side of the surrounding subpart 5121 close to the cell 2. By the above arrangement, the surrounding subpart 5121 is prevented from contacting a second electrode plate of the main body portion 21 to cause the short circuit, and a pressure borne by the first current collecting member 51 is also buffered when the top cover 3 and the housing 1 are pier-sealed.

The first connection subpart 5122 is fixedly connected to the surrounding subpart 5121, the first connection subpart 5122 has a certain included angle with the surrounding subpart 5121, so that the first connection subpart 5122 is an inclined plane, and the first connection subpart 5122 is attached to the first tab unit 22, and is subjected to laser keyhole welding, resistance welding or ultrasonic welding with the first tab unit 22. The first connection subpart 5122 is a plate-shaped arc structure, a side with a smaller arc length is connected to the surrounding subpart 5121, and a side with a larger arc length is connected to the second connection subpart 5123. The second connection subpart 5123 is a plate-shaped arc structure, the second connection subpart 5123 is parallel to the top cover 3, and the second connection subpart 5123 is attached to the first tab unit 22. The insulating part 53 is sleeved on the second connection subpart 5123 for preventing the second connection subpart 5123 from contacting the top cover 3 or the housing 1 to cause the short circuit of the cylindrical battery. Since the first connection subpart 5122 and the second connection subpart 5123 are electrically connected to the first tab unit 22 at the same time, a current passing area of the tab is increased.

As shown in FIG. 11, in some embodiments, the insulating part 53 is also arranged between the first current collecting member 51 and the top cover 3 for insulating the first current collecting member 51 from the top cover 3. Since polarities of the first current collecting member 51 and the top cover 3 are opposite, the insulating part 53 is arranged between the first current collecting member 51 and the top cover 3 so that the first current collecting member 51 is prevented from directly contacting the top cover 3 to cause the short circuit of the cylindrical battery.

As shown in FIGS. 3-6 and FIG. 10, in some embodiments, the fourth groove 71 is formed in a surface of the top cover 3 away from the cell 2, and the fourth groove 71 is configured to be welded to the second current collecting member 52. Since the first tab unit 22 and the second tab unit 23 are led out from the same end of the cell 2, when the fourth groove 71 is not arranged, a welding position needs to be found before the second current collecting member 52 and the top cover 3 are welded. However, the fourth groove 71 is arranged, and during welding, the welding head is directly aligned with the fourth groove 71 for welding, without further positioning. Meanwhile, since the fourth groove 71 is a groove, a thickness of the top cover 3 at the fourth groove 71 is the smallest, and welding is performed more easily. It should be noted that the fourth groove 71 is arranged in an arc-shaped strip structure. In an embodiment, the top cover 3 is also provided with an explosion-proof weakness part 74, the explosion-proof weakness part 74 has the same shape and structure as the fourth groove 71, and the explosion-proof weakness part 74 and the fourth groove 71 are arranged symmetrically with respect to the electrode terminal 4. The explosion-proof weakness part 74 is obtained by laser engraving and stamping.

As shown in FIG. 13, a battery module 6 according to an embodiment of the disclosure includes a box 61 and the cylindrical battery 62 of the above embodiment accommodated in the box 61.

The box 61 is configured to accommodate the cylindrical battery, and the box 61 has various structures. In some embodiments, the box 61 includes a first box portion 611, a second box portion 612 and a third box portion 613. The first box portion 611 and the second box portion 612 cover the third box portion 613. The first box portion 611, the second box portion 612 and the third box portion 613 jointly define an accommodating space for accommodating the cylindrical battery 62. The third box portion 613 is a hollow structure with openings at two ends. The first box portion 611 and the second box portion 612 are plate-shaped structures, the first box portion 611 covers an opening side of the third box portion 613, and the second box portion 612 covers the other opening side of the third box portion 613 to form the box 61 having the accommodating space. The first box portion 611 and the second box portion 612 is also a hollow structure with an opening at one side, an opening side of the first box portion 611 covers the opening side of the third box portion 613, and an opening side of the second box portion 612 covers the third box portion 613 to form the box 61 having the accommodating space. Of course, the first box portion 611, the second box portion 612 and the third box portion 613 are in various shapes, such as cylinder, cuboid, etc.

In order to improve a sealing performance after the first box portion 611, the second box portion 612 and the third box portion 613 are connected, the sealing part 72 such as a sealant or a seal ring is also arranged between the first box portion 611 and the third box portion 613 and between the second box portion 612 and the third box portion 613.

In the battery module 6, there are one or more cylindrical batteries 62. If there are a plurality of cylindrical batteries 62, the plurality of cylindrical batteries 62 are connected in series, in parallel or in parallel-series. The parallel-series connection means that the plurality of cylindrical batteries 62 is connected in series and in parallel. The plurality of cylindrical batteries 62 are directly connected in series, in parallel or in parallel-series, and then the whole of the plurality of cylindrical batteries 62 is accommodated in the box 61. Of course, the plurality of cylindrical batteries 62 are also connected in series, in parallel or in parallel-series to form a battery module, a plurality of battery modules are connected in series, in parallel or in parallel-series to form a whole, and are accommodated in the box 61.

In some embodiments, the plurality of cylindrical batteries 62 in the battery module 6 are electrically connected by a busbar, so as to achieve parallel connection, series connection or parallel-series connection of the plurality of batteries in the battery module 6.

According to the disclosure and teaching of the above specification, those skilled in the art to which the disclosure pertains can also change and modify the above embodiments. Therefore, the disclosure is not limited to the above specific embodiments, and any obvious improvement, substitution or modification made by those skilled in the art on the basis of the disclosure shall fall within the protection scope of the disclosure. In addition, although some specific terms are used in the specification, these terms are only for convenience of description and do not constitute any limitation to the disclosure.

What is claimed is:

1. An electrode terminal, comprising:
a columnar portion, an end surface of the columnar portion is concave inwards to form a first groove;
a first extension portion, extending outwards along a circumferential direction of the end surface of the columnar portion formed with the first groove; and
an electric connection portion which is formed at an end of the columnar portion away from the first groove.

2. The electrode terminal according to claim 1, wherein a second groove is formed in a side surface of the columnar portion.

3. The electrode terminal according to claim 1, wherein a third groove is formed in a surface of the columnar portion away from the first groove.

4. The electrode terminal according to claim 3, wherein the third groove is arranged around the electric connection portion.

5. The electrode terminal according to claim 4, wherein the third groove is an annular continuous groove, or an annular discontinuous groove.

6. A current collecting assembly for electric connection to the electrode terminal according to claim 1, comprising:
a first current collecting member, comprising a first protrusion, an end surface of the first protrusion is provided with a first welding portion, the first protrusion is embedded in the first groove of the columnar portion, and the first protrusion and the first groove are welded at the first welding portion; and
a second current collecting member, the first current collecting member is insulated from the second current collecting member.

7. The current collecting assembly according to claim 6, wherein the first welding portion is located in the third groove of the columnar portion.

8. The current collecting assembly according to claim 6, wherein the first current collecting member and the second current collecting member are arranged separately.

9. The current collecting assembly according to claim 6, wherein the current collecting assembly further comprises an insulating part, the insulating part is configured for insulating connection with the first current collecting member and the second current collecting member, and the insulating part, the first current collecting member and the second current collecting member are integrally molded.

10. The current collecting assembly according to claim 9, wherein the insulating part is provided with a through hole and an opening area, the first current collecting member is installed in the insulating part, the first protrusion passes through the through hole, the opening area is at least arranged on one side away from the first protrusion, at least a part of one side of the first current collecting member away from the first protrusion is exposed in the opening area, and the first current collecting member and the second current collecting member both form a welding area on one side away from the first protrusion.

11. A cylindrical battery, comprising:
the current collecting assembly and the electrode terminal both according to claim 6;
a housing and a cell, the cell comprises a main body portion as well as a first tab unit and a second tab unit respectively arranged on the main body portion and opposite in polarity, and the cell is accommodated in the housing; and
the first current collecting member is electrically connected to the first tab unit, and the second current collecting member is electrically connected to the second tab unit.

12. The cylindrical battery according to claim 11, wherein the housing comprises a bottom wall and a side wall arranged on the edge of the bottom wall, the cylindrical battery further comprises a top cover covering the housing, the top cover is provided with an electrode lead-out hole, and the electrode terminal passes through the electrode lead-out hole and is fixed to the top cover in an insulated manner by a sealing part.

13. The cylindrical battery according to claim 12, wherein the first current collecting member is welded to the first tab unit, and the second current collecting member is welded to the second tab unit.

14. The cylindrical battery according to claim 12, wherein the first tab unit and the second tab unit are led out from the same end of the main body portion, the first current collecting member is connected to the second current collecting member in a combined manner by an insulating part, and the top cover is welded to the second current collecting member.

15. The cylindrical battery according to claim 12, wherein a fourth groove is formed in a side of the top cover away from the cell, and the fourth groove is configured to be welded to the second current collecting member.

16. The cylindrical battery according to claim 11, wherein
a second groove is formed in a side surface of the columnar portion of the electrode terminal; and/or
a third groove is formed in a surface of the columnar portion of the electrode terminal away from the first groove.

17. The cylindrical battery according to claim 16, wherein
the third groove is arranged around the electric connection portion of the electrode terminal; and/or
the third groove is an annular continuous groove, or an annular discontinuous groove.

18. The cylindrical battery according to claim 11, wherein
the first welding portion is located in the third groove of the columnar portion of the electrode terminal; and/or
the first current collecting member and the second current collecting member of the current collecting assembly are arranged separately.

19. The cylindrical battery according to claim 11, wherein the current collecting assembly further comprises an insulating part, the insulating part is configured for insulating connection with the first current collecting member and the second current collecting member, and the insulating part, the first current collecting member and the second current collecting member are integrally molded.

20. The cylindrical battery according to claim 19, wherein the insulating part is provided with a through hole and an opening area, the first current collecting member is installed in the insulating part, the first protrusion passes through the through hole, the opening area is at least arranged on one side away from the first protrusion, at least a part of one side of the first current collecting member away from the first protrusion is exposed in the opening area, and the first current collecting member and the second current collecting member both form a welding area on one side away from the first protrusion.
